(19) United States
(12) Patent Application Publication
(10) Pub. No.: US 2026/0017497 A1
(43) Pub. Date: Jan. 15, 2026

(54) SELF-SUPERVISED LEARNING FOR REAL-TIME CLICKSTREAM DATA

(71) Applicant: Capital One Services, LLC, McLean, VA (US)

(72) Inventors: Daniel HILGART, McLean, VA (US); Jisi LIU, McLean, VA (US); Patrick BARRANGER, McLean, VA (US); James O. H. MONTGOMERY, McLean, VA (US); Gang MEI, Ellicott City, MD (US); Scott GREGOIRE, McLean, VA (US)

(73) Assignee: Capital One Services, LLC, McLean, VA (US)

(21) Appl. No.: 18/773,534

(22) Filed: Jul. 15, 2024

(51) Int. Cl. G06N 3/0475; G06F 18/20; G06N 3/0455; G06N 3/088

(52) U.S. Cl. CPC G06N 3/0475; G06F 18/20; G06N 3/0455; G06N 3/088

(57) ABSTRACT

Methods and systems are described herein for generating embeddings representing real-time interactions of a user device with a server to be used by a downstream model. For example, the downstream model may be trained to select and provide data to a user of the user device based on the embedding. In some embodiments, an artificial intelligence model may be trained using self-supervised learning to reconstruct real-time interactions of the user during a current user session. The artificial intelligence model, for example, an auto-encoder, may be trained using reference real-time interactions of the user to generate embeddings that can be mapped to predicted reconstructions of the real-time interactions. The artificial intelligence model can be trained by minimizing a loss computed from the reference real-time interactions and the reconstructions of the real-time interactions.

### BACKGROUND

User interactions with website or mobile applications can provide tremendous insights into the behaviors of those users. However, these insights are primarily analyzed in batches, well after those interactions have occurred. This is mostly a result of the sparseness of real-time interaction data, which makes modeling those interactions difficult.

### SUMMARY

Methods and systems are described herein for selecting and providing data to a user based on a real-time analysis of interactions of the user and a server. The real-time analysis can produce an embedding that represents the user's real-time interactions. The embedding can then be served to one or more downstream models for real-time analysis and prediction. This is particularly useful when a user is “new.” In such cases, existing data about the user may not be available or may be sparse. The techniques described herein overcome this and other technical challenges by training an artificial intelligence model, such as a transformer model, to generate embeddings describing a user's real-time interactions with a website. This embedding can then be used by downstream models to make real-time predictions and provide data, services, or other information to the user.

To learn how to generate embeddings using such sparse data, an artificial intelligence model, for example, an auto-encoder or a decoder-only transformer model, is trained to reconstruct real-time interactions. A self-supervised learning process is deployed that inputs reference real-time interactions into the artificial intelligence model. An embedding layer of the artificial intelligence model learns to generate embeddings that encode and compress the interactions into a machine-processable representation, such as a vector. The artificial intelligence model may generate a reconstructed version of the reference real-time interactions from the embedding, for example, using a decoder. The artificial intelligence model's parameters can be trained to generate embeddings that more accurately reconstruct the input interactions by optimizing a loss computed based on the real-time interactions and the model-produced reconstructions.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example system for selecting and providing data to a user based on a real-time analysis of interactions of a user and a server, in accordance with one or more embodiments.

FIG. 2 illustrates example event data, in accordance with one or more embodiments.

FIG. 3 illustrates example content data, in accordance with one or more embodiments.

FIG. 4 illustrates an example process for training an artificial intelligence model to reconstruct event data using self-supervised learning, in accordance with one or more embodiments.

FIG. 5 illustrates an example system for selecting and providing data to a user based on a real-time analysis of interactions of a user and a server and training an artificial intelligence model to select the data, in accordance with one or more embodiments.

FIG. 6 illustrates a flowchart of an example process for selecting and providing data to a user based on a real-time analysis of interactions of a user and a server, in accordance with one or more embodiments.

FIG. 7 illustrates a flowchart of an example process for training an artificial intelligence model to generate embeddings representing real-time interactions of a user and a server, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

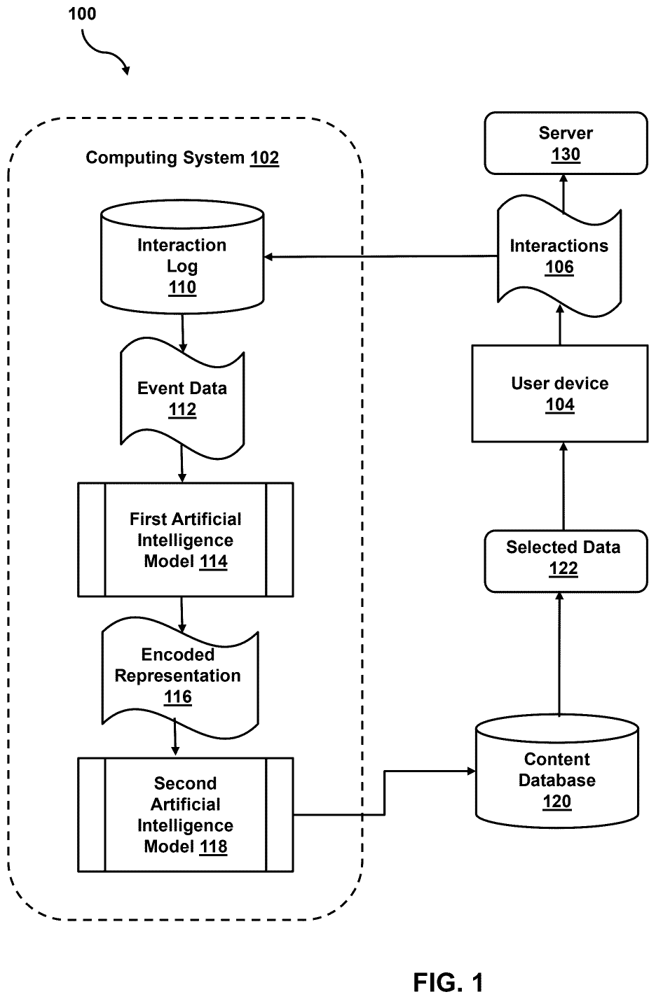

FIG. 1 illustrates an example system 100 for selecting and providing data to a user based on a real-time analysis of interactions of a user and a server, in accordance with one or more embodiments. System 100 may include a computing system 102, a user device 104, a server 130, or other components. In some embodiments, system 100 may further include one or more databases, such as content database 120. Persons of ordinary skill in the art will recognize that although a single instance of computing system 102, user device 104, server 130, and content database 120 are illustrated, one or more additional instances of each of these components may be included. Furthermore, computing system 102, user device 104, content database 120, server 130, and/or any other devices, servers, and/or systems may communicate with one another using one or more networks, such as the Internet.

In some embodiments, the user may be associated with an account of a service provider hosted by server 130. Server 130 may provide one or more services, products, or other features to users via one or more websites, mobile applications, or other content sources. As an example, server 130 may be associated with a financial service provider and may provide one or more financial services (e.g., credit cards, loans, etc.) to one or more users having accounts with the financial service provider. As another example, server 130 may be associated with a social media provider and may provide one or more social networking services (e.g., image sharing, professional networking, etc.) to one or more users having accounts with the social media provider. As additional examples, the services provided by server 130 may include a healthcare service, an educational service, a transactional service, a utility service, and the like. In some examples, server 130 may represent an ensemble of service providers that share data with one another and provide various services to users having accounts with these service providers.

User device 104 may be operated by a user or multiple users. For example, a user device 104 may have an account with a service provider hosted by server 130 or may be used to access the account with the service provider hosted by server 130. In some embodiments, user devices 104 may be computing devices that may interact in real time with server 130 to access services offered by one or more service providers hosted by server 130. For example, real-time interactions 106 may represent various interactions that a user can take to access one or more services of a service provider hosted by server 130. For example, real-time interactions 106 may include mouse clicks, drags, scrolls, touch inputs, hovering actions, eye tracking, motion tracking, dwell time, and the like. In some embodiments, real-time interactions 106 may represent one or more interactions detected to occur during a user session with the service provider hosted by server 130. In some examples, an interaction represented by real-time interactions 106 may correspond to a selection by a user of a hyperlink directed to a particular resource locator address.

User devices 104 may be end-user computing devices (e.g., desktop computers, laptops, electronic tablets, smartphones, and/or other computing devices used by end users). User devices 104 may output (e.g., via a graphical user interface) data, run applications, output communications, receive inputs, or perform other actions. In some examples, users may access the services provided by server 130 using an application programming interface (API), a mobile application, a website, or the like running on user device 104.

In some embodiments, computing system 102 may be in communication with, or form a component of, server 130 hosting the service provider(s). In other words, a service provider may leverage aspects of computing system 102 to analyze data, receive requests, generate responses, select data to be provided to a user, and provide the selected data to the user.

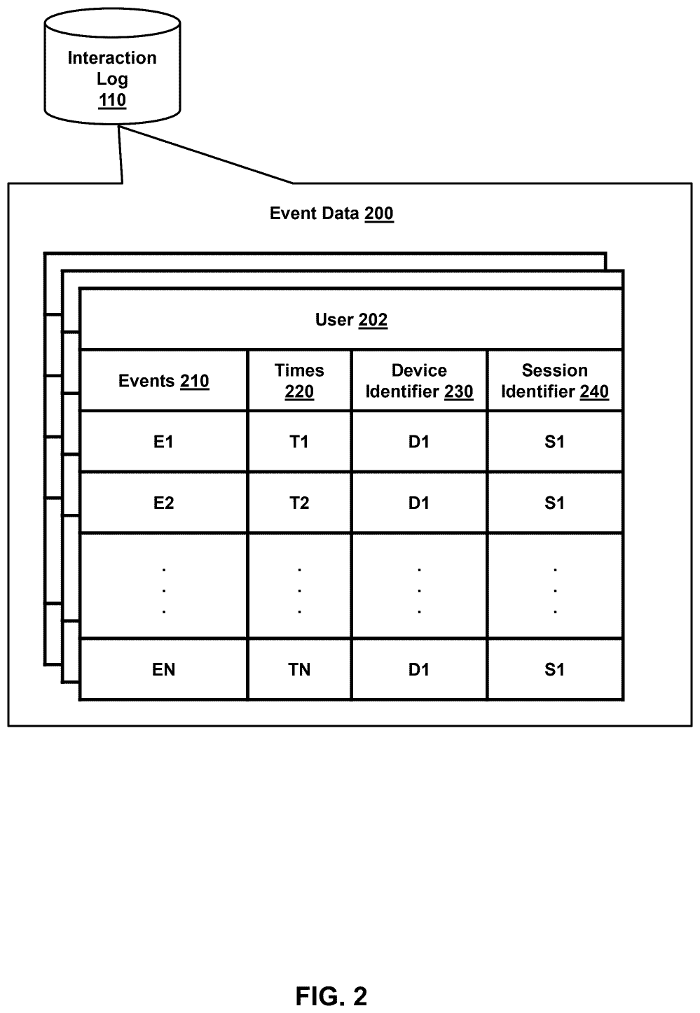

Computing system 102 may include an interaction log 110 that receives and stores real-time interactions 106. Interaction log 110 may store event data, such as event data 200 of FIG. 2. As seen in FIG. 2, event data 200 may include data describing various sequences of events of various users 202. For each user 202, data may be stored that includes events 210, times 220, device identifier 230, session identifier 240, or other information.

Events 210 may correspond to each real-time interaction detected to occur between user device 104 and server 130. For example, events 210 may include events E1-EN. Each of events E1-EN may represent a different interaction detected between user device 104 and server 130. As an example, event E1 may correspond to a user selection of a hyperlink via user device 104. Event E2 may correspond to a user scrolling 25% of a webpage visited in response to the user selection of the hyperlink. Event EN may correspond to a user session ending, for example, via closing the webpage, selecting another hyperlink presented on the webpage, a threshold amount of time elapsing since an interaction with the webpage was detected, and the like.

Each of events 210 may occur at a corresponding one of times 220. For example, event E1 may occur at time T1, event E2 may occur at time T2, and event EN may occur at time TN. The amount of time between each of events 210 may vary. For example, an amount of time between event E1 and event E2 may differ from an amount of time between event E2 and event E3 (occurring sequentially after event E2). In some embodiments, the time difference between each event may also be calculated and stored with times 220. Furthermore, in some examples, times 220 may include time intervals during which a particular event occurred. For example, if event E2 corresponds to the playing of a video or other media via user device 104, then time T2 may include a start time of the video, an end time of the video, and a duration of the video.

Event data 200 of users 202 may also include additional information, such as device identifiers 230 and session identifiers 240. Device identifiers 230 may represent an identifier of user device 104 with which a corresponding interaction was detected. For example, if event E1 corresponds to the selection of a hyperlink, then device identifier DI may indicate a MAC address, IP address, serial number, or other identifier associated with user device 104. Session identifiers 240 may indicate a user session during which real-time interactions 106 occurred.

A user session may represent a particular collection of interactions that occur between a user (via a user device, such as user device 104) and a service provider (such as a service provider hosted by server 130). A user session may be initiated in response to a trigger. Some example triggers may include a hyperlink to a website hosted by server 130 being selected, a mobile application associated with the service provider being downloaded and/or opened, a message being received by the service provider from user device 104, and the like. During a given user session, each interaction that occurs between user device 104 and server 130 may be tracked and logged as an event (e.g., events 210). In some embodiments, a first interaction with a service provider hosted by server 130 may cause a data structure to be created, as seen by event data 200, with a first session identifier. Each subsequent user session may thus include a different session identifier to uniquely qualify those events as occurring during the subsequent user session.

In some embodiments, computing system 102 may be configured to determine whether a session stopping condition has been satisfied. If the session stopping condition has been satisfied, then the current user session may end. In some examples, ending the current user session may include preventing data from being accessed via a user interface rendered on user device 104. As an example, determining the session stopping condition has been satisfied may include determining that a threshold amount of time has elapsed since a most recent interaction was detected between user device 104 and server 130. As another example, determining the session stopping condition has been satisfied may include determining that a graphical user interface (e.g., an interactive element, button, etc.) rendered on the user interface has been selected. As yet another example, determining the session stopping condition has been satisfied may include determining that a request to stop rendering of the user interface has been received from user device 104.

Returning to FIG. 1, computing system 102 may be configured to determine whether a user session between user device 104 associated with a user and server 130 has been initiated. In some examples, computing system 102 may receive a notification that user device 104 has accessed a webpage associated with server 130. For example, the webpage may be hosted by server 130. A user may access the webpage by selecting a hyperlink directed to the webpage, where the hyperlink can be selected via a user interface displayed on a display component of user device 104. In response to determining that the user has accessed the webpage, computing system 102 may be configured to generate a session identifier for the user session based on the notification. In some examples, the notification may include a time that the webpage was accessed, a device identifier (e.g., device identifier 230) of user device 104 that accessed the webpage, a location (or other information) of user device 104, and the like. Each of the real-time interactions (e.g., real-time interactions 106) may be stored in association with the session identifier, as described above with reference to FIG. 2, interaction log 110.

In some embodiments, computing system 102 may be configured to extract event data 112 detected during the user session. Event data 112 may represent real-time interactions, such as real-time interactions 106 of user device 104 with server 130. The real-time interactions may include inputs detected by user device 104 while the user visits a webpage hosted by server 130. The real-time interactions may also include inputs provided by user device 104 to the webpage, as well as data provided by the webpage for consumption by user device 104. In some embodiments, event data 112 may be the same or similar to event data 200 of FIG. 2.

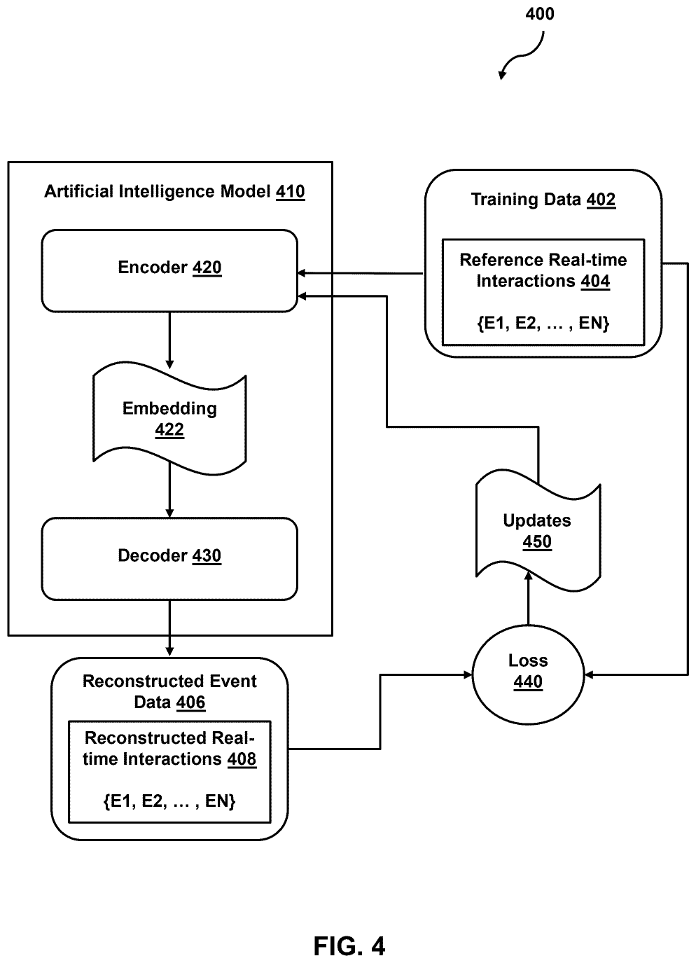

In some embodiments, computing system 102 may be configured to input, during the user session, event data 112 into a first artificial intelligence model 114 to obtain an encoded representation 116 of the real-time interactions. First artificial intelligence model 114, as detailed below with respect to FIG. 4, may be trained by minimizing a loss between reference real-time interactions and reconstructed real-time interactions.

In some embodiments, inputting event data 112 into first artificial intelligence model 114 to obtain encoded representation 116 of the real-time interactions (e.g., real-time interactions 106) may include tokenizing the real-time interactions to obtain a plurality of interaction tokens. Each interaction token represents one of the real-time interactions. A plurality of token-level encoded representations may be generated for the plurality of interaction tokens. Each encoded representation of the real-time interactions comprises the plurality of token-level encoded representations. As an example, each token-level encoded representation is an embedding representing a given real-time interaction. Encoded representation 116 may represent each token-level encoded representation, an average of the token-level encoded representations, an aggregation or combination of the token-level encoded representations, etc.

In some embodiments, computing system 102 may be configured to provide, during the user session, encoded representation 116 to a second artificial intelligence model 118. Second artificial intelligence model 118 may be trained to select data 122 (e.g., first data) to be presented within a user interface to be rendered using user device 104. Selected data 122 may be retrieved from content database 120. In some examples, data 122 may be selected based on other data (e.g., second data) provided to one or more other users determined to be similar to the user.

In one or more examples, second artificial intelligence model 118 may be executed using hardware and software components of computing system 102, as in the case of first artificial intelligence model 114. However, alternatively, in some embodiments, second artificial intelligence model 118 may be hosted on another computing system, server, device, or a combination thereof. Therefore, the inclusion of second artificial intelligence model 118 within computing system 102 should not be construed as limiting the present disclosure.

In some embodiments, second artificial intelligence model 118 may be trained to identify one or more users whose user behaviors are similar to that of the user of user device 104 during the current user session. For example, second artificial intelligence model 118 may compute a similarity metric between a user whose real-time interactions are represented by encoded representation 116 and one or more other users that have also interacted with server 130 (i.e., one or more service providers hosted by server 130). Depending on which users are identified as being “similar,” second artificial intelligence model 118 may identify data 122 that was previously provided to the similar user(s), previously accessed by those users, previously shared by those users, and/or stored by those users and may provide data 122 to user device 104.

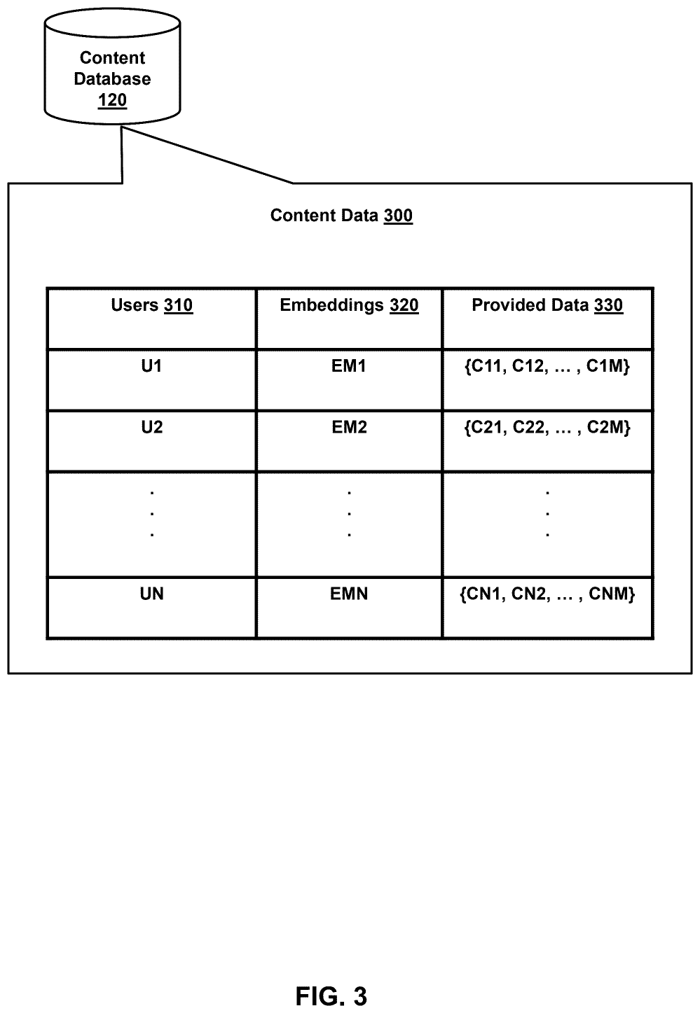

In some embodiments, second artificial intelligence model 118 may be configured to select data 122 from content data 300 stored in content database 120, as illustrated by FIG. 3. Content data 300 may include users 310, embeddings 320, and provided data 330. Users 310 may correspond to users, such as users U1-UN, with whom data has previously been provided. For example, users 310 may refer to other users having accounts with a service provider hosted by server 130. Each of users 310 may have previously interacted with server 130 and, as a result, may have been provided data based on those interactions. Embeddings 320 may represent embeddings or other encoded representations generated by first artificial intelligence model 114 or another trained encoder. Embeddings 320 may represent real-time interactions of a corresponding user with server 130. In some embodiments, embeddings 320 may store multiple embeddings. For example, embeddings 320 may include an embedding representing real-time interactions between that user and a server for one or more user sessions, an embedding representing all prior interactions between the user and the server, additional information known or derived about the user (e.g., location data, device information, etc.), etc. Provided data 330 may include identifiers for difference data that has been provided to a corresponding user. For example, user U1 may have been provided data including content items C11, C12, . . . , C1M, while user U2 may have been provided data including content items C21, C22, . . . , C2M, and so on. In some embodiments, provided data 330 may be selected for each of users 310 based on a similarity between embeddings 320 of users 310.

In one or more examples, the similarity between embeddings 320 may be determined by calculating a cosine distance or other feature distance metric between embeddings 320. In this example, a cosine distance that is small may indicate that two users' embeddings are located proximate one another in an embedding space, whereas a cosine distance that is large may indicate that two users' embeddings are located far apart in the embedding space. Those “similar” users may have small cosine distances, and “unsimilar” users may have large cosine distances. As another example, a model can be trained offline on a supervised learning task. This model can then be used to select which content items to provide. In some cases, the probability may be a function of how likely it is that a content item may be interacted with in a particular manner. For example, the content item may feature an offer that causes a user to input information (e.g., personal information, financial information, communication information, etc.). If the user inputs that information, and/or performs one or more additional tasks, then the user may be provided with the offer. As an illustrative example, the model may receive, as input, the embeddings, a type of content shown, and/or other features. The model may be trained offline to output a probability of a successful conversion of the offer.

Returning to FIG. 1, in some embodiments, a user interface may be generated during the user session. The user interface may be rendered using user device 104. The user interface may include at least some of data 122 (e.g., content C11, C12, . . . , C1M of FIG. 3). Data 122 may include video data, image data, text data, instructions, application data, or other data. For example, data 122 may include a video comprising content determined as being relevant to a user based on the user's interactions (e.g., real-time interactions 106) with server 130. The user interface may also be provided to user device 104 during the user session. In addition, instructions may be provided to user device 104 to cause the user interface to be rendered.

In some embodiments, during the (same) user session, the user interface may be updated. For instance, the user interface may be updated to include additional data determined based on one or more additional real-time interactions of the user with server 130 detected during the user session subsequent to the user interface being provided to user device 104. In some cases, updated event data including an updated set of real-time interactions may be generated. The updated event data may also be generated during the user session. The updated event data may include the real-time interactions and the one or more additional real-time interactions. In some embodiments, the additional interactions may be provided as they are detected (i.e., in real time). For example, as each interaction between user device 104 and server 130 is detected, the interaction may be provided to computing system 102 and used to formulate a new or updated version of encoded representation 116, which represents the interactions detected during the user session. Upon receiving the updated event data, during the user session, first artificial intelligence model 114 may be configured to generate an encoded representation representing the updated set of real-time interactions. This encoded representation, for instance, may be generated using the encoder of first artificial intelligence model 114. This encoded representation may, subsequent to being generated, be input into second artificial intelligence model 118 to obtain the additional data to be provided to user device 104 via the updated user interface. For example, based on the additional interactions detected between user device 104 and server 130, a new embedding may be generated, and this new embedding may indicate that the user operating user device 104 exhibits behaviors more similar to another user. Therefore, the additional data may be selected from content database 120 based on the data previously provided to that other user.

In some embodiments, computing system 102 may be configured to determine whether a session stopping condition has been satisfied. If the session stopping condition has been satisfied, then the current user session may end. In some examples, ending the current user session may include preventing data from being accessed via a user interface rendered on user device 104. As an example, determining the session stopping condition has been satisfied may include determining that a threshold amount of time has elapsed since a most recent interaction was detected between user device 104 and server 130. As another example, determining the session stopping condition has been satisfied may include determining that a graphical user interface (e.g., an interactive element, button, etc.) rendered on the user interface has been selected. As yet another example, determining the session stopping condition has been satisfied may include determining that a request to stop rendering of the user interface has been received from user device 104.

In some embodiments, first artificial intelligence model 114 may be a transformer model or may include a transformer-like architecture. For example, first artificial intelligence model 114 may include an encoder and a decoder. The encoder portion of first artificial intelligence model 114 may be trained to generate embeddings representing real-time interactions, and the decoder portion of first artificial intelligence model 114 may be trained to reconstruct the real-time interactions based on the embeddings. To train first artificial intelligence model 114, a self-supervised learning process may be used. By “self-supervised learning,” it is to be understood that first artificial intelligence model 114 is able to be trained without the need for labeled data. In other words, first artificial intelligence model 114 learns how to generate embeddings that accurately represent real-time interactions by tuning its parameters (e.g., weights, biases) to minimize a difference between the real-time interactions and the reconstructed real-time interactions.

An example of a training process 400 for training an artificial intelligence model 410 to generate an embedding representing real-time interactions of user device 104 and server 130 is illustrated in FIG. 4. In FIG. 4, artificial intelligence model 410 may correspond to first artificial intelligence model 114 of FIG. 1. After training has completed, artificial intelligence model 410, or a portion thereof, may be deployed or used to deploy first artificial intelligence model 114. For example, artificial intelligence model 410 may comprise an auto-encoder, including an encoder 420 and a decoder 430. After training, encoder 420 may be used as first artificial intelligence model 114, or parameter values of parameters of encoder 420 may be used as first artificial intelligence model 114.

In some embodiments, training process 400 for training artificial intelligence model 410 may include retrieving training data 402 including a plurality of sets of reference real-time interactions 404 each associated with a reference user. Each set of reference real-time interactions may comprise interactions between the reference user and a server, such as server 130. For example, as seen in FIG. 4, reference real-time interactions 404 may include events E1, E2, . . . , EN. Each event may correspond to an interaction between a given reference user (e.g., one of users 202) and server 130. As an example, the first event may correspond to a user accessing a webpage by selecting a hyperlink directed toward that webpage's resource locator. In some embodiments, reference real-time interactions 404 included within training data 402 may be derived from real interactions of users with server 130. In other words, reference real-time interactions 404 may be synthetically generated for a reference user (e.g., a synthetic user or a real-prior user). In some examples, one or more generative models may be trained to generate synthetic interaction data based on actual interactions of users with server 130. Alternatively, reference real-time interactions 404 may represent a portion of, or all of, the interactions that have previously occurred between a reference user and server 130.

In some embodiments, training process 400 may include selecting a (first) set of reference real-time interactions, such as reference real-time interactions 404, from the sets of reference real-time interactions included in training data 402. The set of reference real-time interactions may be selected randomly from some or all of the reference real-time interactions of training data 402. As an example, reference real-time interactions 404 may include a sequence of events that each occur at a different time during a given user session.

After reference real-time interactions 404 have been selected, reference real-time interactions 404 may be input to encoder 420 of artificial intelligence model 410. Encoder 420 may be configured to generate an encoded representation, for example, an embedding 422, representing reference real-time interactions 404. Embedding 422 may be input to decoder 430 of artificial intelligence model 410. Decoder 430 may be trained to generate reconstructed event data 406 including a set of reconstructed real-time interactions 408 based on embedding 422. Reconstructed real-time interactions 408 may represent a model reconstruction of reference real-time interactions 404 input to the encoder.

Embeddings may be representations of events in a continuous vector space. Event embeddings may be similar to word embeddings in NLP, where words are represented as dense vectors in a continuous space, capturing semantic relationships between words. In the context of event data or sequences of events, embeddings may encode information about events, their relationships, and contextual dependencies. Thus, embeddings can be referred to herein interchangeably as “encoded representations.”

These embeddings may be created using various techniques and may be used in sequential data analysis, non-sequential data analysis, recommendation systems, time series analysis, and other applications dealing with event sequences. In some embodiments, an event embedding may be generated using sequential models (e.g., recurrent neural networks (RNNs), transformers, etc.). Models such as RNNs or transformer architectures may learn embeddings from event sequences by processing them sequentially. These models may capture dependencies between events and generate embeddings based on the sequence context. Temporal convolutional networks (TCNs) use convolutional operations to learn event embeddings by considering temporal dependencies in event sequences. Event data may also be represented as a graph, where events are nodes and relationships between events are edges. Graph embedding techniques may aim to learn representations for events based on their connectivity and interactions in the graph. Event embeddings may capture various properties of events, such as event types, temporal relationships, contextual information, and dependencies among events in a sequence. These embeddings may be used in downstream tasks like event prediction, anomaly detection, recommendation systems, and more, providing a compact and meaningful representation of event data. Furthermore, embeddings may be processable by decoders, such as decoder 430, for mapping the embedding to an original data space. For example, decoder 430 may map an embedding representing a sequence of events (e.g., real-time interactions) to a predicted sequence of events (e.g., reconstructed real-time interactions).

To determine how well artificial intelligence model 410 performed, a loss 440 may be computed. Loss may be determined using reference real-time interactions 404 and reconstructed real-time interactions 408. The greater loss 440 is, the worse a job artificial intelligence model 410 did at reconstructing reference real-time interactions 404. Conversely, a small loss 440 may indicate that artificial intelligence model 410 was able to accurately reconstruct reference real-time interactions 404.

In some embodiments, one or more updates 450 to artificial intelligence model 410 may be determined based on loss 440. Updates 450 may comprise instructions to adjust a parameter value of one or more parameters of artificial intelligence model 410. In particular, updates 450 may cause one or more weights, biases, or other settings of encoder 420 to be adjusted to minimize loss 440. This optimization process allows encoder 420 to learn the best way to represent reference real-time interactions 404.

After updates 450 have been performed, training process 400 may include a step of determining whether one or more stopping conditions associated with the training have been satisfied. As an example, the stopping conditions may be satisfied based on a determination that each set of reference real-time interactions included in training data 402 has been analyzed. As another example, the stopping conditions may be satisfied based on a determination that loss 440 computed from a given set of reference real-time interactions (e.g., reference real-time interactions 404) and a corresponding set of reconstructed real-time interactions (e.g., reconstructed real-time interactions 408) is less than a threshold loss. As yet another example, the stopping condition may be satisfied based on a determination that a predefined number of training epochs have been performed or a training time has elapsed.

If it is determined that one or more of the stopping conditions have been satisfied, then training process 400 may stop. Upon training process 400 stopping, encoder 420 may be deployed as first artificial intelligence model 114, as illustrated in FIG. 1. In some embodiments, instead of deploying encoder 420 as first artificial intelligence model 114, parameter values of parameters of encoder 420 (e.g., weights, biases, etc.) may be provided to another artificial intelligence model. This other artificial intelligence model may be deployed as first artificial intelligence model 114 or, alternatively, may be further trained (e.g., fine-tuned on additional training data) before being deployed as first artificial intelligence model 114.

If it is determined that none of the stopping conditions have been satisfied, training process 400 may repeat. For example, another set of reference real-time interactions may be selected from training data 402 and provided to encoder 420 of artificial intelligence model 410. An embedding may be generated using encoder 420 based on the other set of reference real-time interactions. This embedding may be input to decoder 430 to reconstruct the additional reference real-time interactions. A loss may be computed based on the additional reference real-time interactions and the additional reconstructed real-time interactions, and one or more parameters of artificial intelligence model 410 (e.g., parameters of encoder 420) may be adjusted to try and minimize the loss. Training process 400 may repeat until one or more of the stopping conditions have been satisfied.

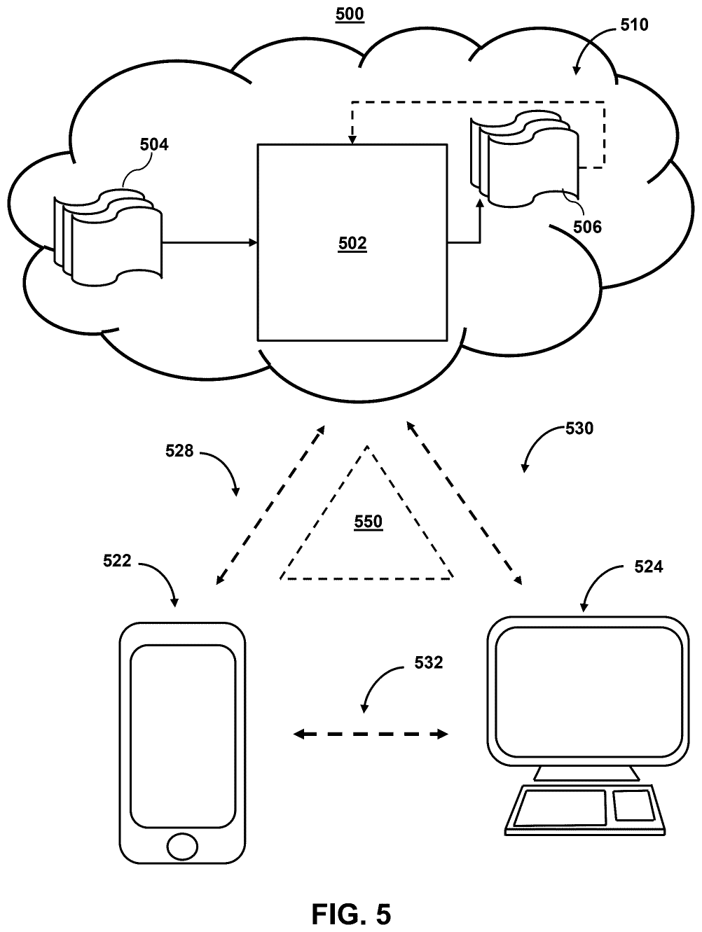

FIG. 5 illustrates an example system 500 for selecting and providing data to a user based on a real-time analysis of interactions of a user and a server and training an artificial intelligence model to select the data, in accordance with one or more embodiments. As shown in FIG. 5, system 500 may include mobile device 522 and user terminal 524. While shown as a smartphone and personal computer, respectively, in FIG. 5, it should be noted that mobile device 522 and user terminal 524 may be any computing device, including, but not limited to, a laptop computer, a tablet computer, a handheld computer, and other computer equipment (e.g., a server), including “smart,” wireless, wearable, and/or mobile devices. FIG. 5 also includes cloud components 510. In some embodiments, mobile device 522 and/or user terminal 524 may represent examples of user devices 104.

Cloud components 510 may alternatively be any computing device as described above and may include any type of mobile terminal, fixed terminal, or other device. For example, cloud components 510 may be implemented as a cloud computing system and may feature one or more component devices. In some embodiments, computing system 102 of FIG. 1 may be implemented as cloud components 510. It should also be noted that system 500 is not limited to three devices. Users may, for instance, utilize one or more devices to interact with one another, one or more servers, or other components of system 500. It should be noted that while one or more operations are described herein as being performed by particular components of system 500, these operations may, in some embodiments, be performed by other components of system 500. As an example, while one or more operations are described herein as being performed by components of mobile device 522, these operations may, in some embodiments, be performed by components of cloud components 510. In some embodiments, the various computers and systems described herein may include one or more computing devices that are programmed to perform the described functions. Additionally, or alternatively, multiple users may interact with system 500 and/or one or more components of system 500. For example, in one embodiment, a first user and a second user may interact with system 500 using two different components.

With respect to the components of mobile device 522, user terminal 524, and cloud components 510, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 5, both mobile device 522 and user terminal 524 include a display upon which to display data.

Additionally, as mobile device 522 and user terminal 524 are shown as a touchscreen smartphone and a personal computer, these displays also function as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 500 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or user devices or (ii) removable storage that is removably connectable to the servers or user devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from user devices, or other information that enables the functionality as described herein.

FIG. 5 also includes communication paths 528, 530, and 532. Communication paths 528, 530, and 532 may include the Internet, a mobile phone network, a mobile voice or data network (e.g., a 5G or LTE network), a cable network, a public switched telephone network, or other types of communications networks or combinations of communications networks. Communication paths 528, 530, and 532 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 510 may include one or more of the components described in FIG. 1. For example, interaction log 110, first artificial intelligence model 114, second artificial intelligence model, content database 120, server 130, and/or other components may be implemented using cloud components 510. Cloud components 510 may also include model 502, which may be a machine learning model, artificial intelligence model, etc. (which may be referred to collectively as “models” herein).

As an illustrative example, model 502 may represent a transformer model, such as the transformer models implemented, executed, and trained in FIG. 1. In some embodiments, model 502 may represent an untrained model or a model being trained; however, persons of ordinary skill in the art will recognize that this is exemplary and model 502 may be a trained artificial intelligence model. In some embodiments, model 502 may represent a “to-be-trained” instance of second artificial intelligence model 118. For example, the process described herein for training model 502 may produce second artificial intelligence model 118. In one or more examples, second artificial intelligence model 118 may be trained to determine one or more embeddings that are within a threshold distance of an embedding produced by first artificial intelligence model 114 for a given set of real-time interactions. Each embedding may be associated with a user who performed those real-time interactions using their corresponding user device 104 to interact with server 130. Second artificial intelligence model 118 may determine data (e.g., content) provided to users similar to the user whose interactions yielded the embedding from first artificial intelligence model 114. Second artificial intelligence model 118 may further be configured to provide, or otherwise cause, the data to the user's corresponding user device 104.

Model 502 may take inputs 504 and provide outputs 506. The inputs may include multiple datasets, such as a training dataset and a test dataset. Each of the plurality of datasets (e.g., inputs 504) may include data subsets related to user data, predicted forecasts and/or errors, and/or actual forecasts and/or errors. In some embodiments, outputs 506 may be fed back to model 502 as input to train model 502 (e.g., alone or in conjunction with user indications of the accuracy of outputs 506, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., consistency of labels, predicted labels, version metadata, etc.).

In some embodiments, where model 502 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, model 502 may be trained to generate better predictions.

In some embodiments, model 502 may include an artificial neural network. In such embodiments, model 502 may include an input layer and one or more hidden layers. Each neural unit of model 502 may be connected with many other neural units of model 502. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 502 may be self-learning and trained, rather than explicitly programmed, and can perform significantly better in certain areas of problem solving as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some embodiments, model 502 may include multiple layers (e.g., where a signal path traverses from front layers to back layers). In some embodiments, backpropagation techniques may be utilized by model 502 where forward stimulation is used to reset weights on the “front” neural units. In some embodiments, stimulation and inhibition for model 502 may be more free-flowing, with connections interacting in a more chaotic and complex fashion. During testing, an output layer of model 502 may indicate whether or not a given input corresponds to a classification of model 502.

System 500 also includes API layer 550. API layer 550 may allow the system to generate summaries across different devices. In some embodiments, API layer 550 may be implemented on mobile device 522 or user terminal 524. Alternatively, or additionally, API layer 550 may reside on one or more of cloud components 510. API layer 550 (which may be a REST or web services API layer) may provide a decoupled interface to data and/or functionality of one or more applications. API layer 550 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 550 may use various architectural arrangements. For example, system 500 may be partially based on API layer 550, such that there is strong adoption of SOAP and RESTful web services, using resources like Service Repository and Developer Portal, but with low governance, standardization, and separation of concerns. Alternatively, system 500 may be fully based on API layer 550, such that separation of concerns between layers like API layer 550, services, and applications are in place.

In some embodiments, the system architecture may use a microservice approach. Such systems may use two types of layers: front-end layer and back-end layer, where microservices reside. In this kind of architecture, the role of API layer 550 may provide integration between front-end and back-end. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols such as gRPC, Thrift, etc.

In some embodiments, the system architecture may use an open API approach. In such cases, API layer 550 may use commercial or open-source API platforms and their modules. API layer 550 may use a developer portal. API layer 550 may use strong security constraints applying WAF and DDOS protection, and API layer 550 may use RESTful APIs as standard for external integration.

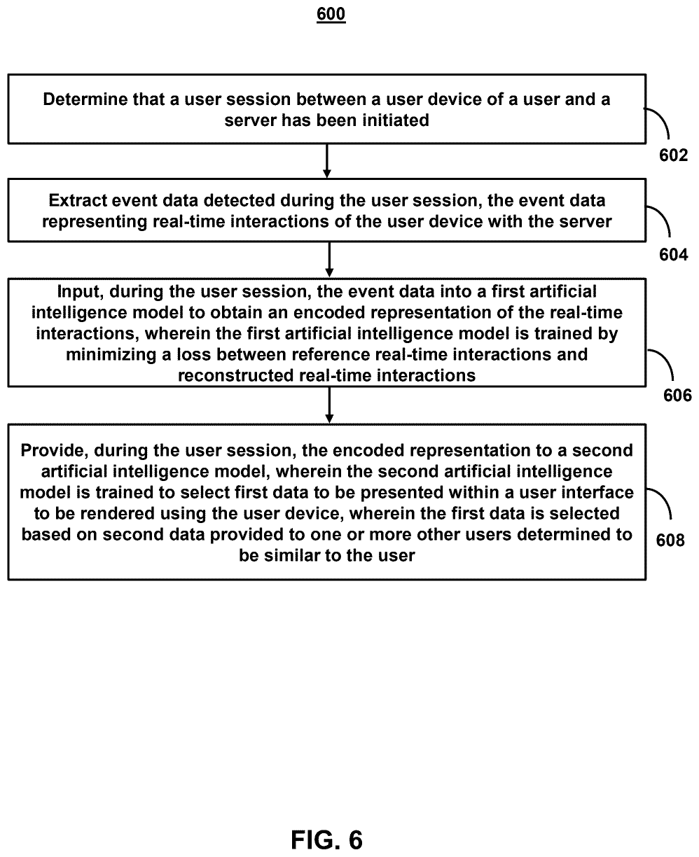

FIG. 6 illustrates a flowchart of an example process 600 for selecting and providing data to a user based on a real-time analysis of interactions of a user and a server, in accordance with one or more embodiments (e.g., as implemented on one or more system components described above). In some embodiments, process 600 may begin at operation 602.

In operation 602, a determination may be made that a user session between a user device of a user and a server has been initiated. In some examples, computing system 102 may receive a notification that user device 104 has accessed a webpage associated with server 130. For example, the webpage may be hosted by server 130. In response to determining that user device 104 has accessed the webpage, computing system 102 may be configured to generate a session identifier for the user session based on the notification. Real-time interactions 106 between user device 104 and server 130 may be stored in association with the session identifier.

In some embodiments, computing system 102 may be configured to access a device identifier of user device 104. For example, a MAC address, IP address, serial number, and/or another means for identifying user device 104 may be detected within data transmitted to/from server 130 and user device 104. Using the device identifier, a determination may be made as to whether the user session is a first user session between user device 104 and server 130. If so, then a first session identifier may be generated and assigned to each event that was detected as being associated with the first session. Determining that the user session is a first user session indicates that this is the first time that user device 104 has interacted with server 130. Therefore, server 130 may not have any prior information about user device 104 and/or the user associated with user device 104. This can make it difficult to model user interactions, such as real-time interactions 106, particularly because the number of events represented by real-time interactions 106 may be sparse (i.e., one or more events, two or more events, three or more events, five or more events, ten or more events, etc.).

If it is not the first user session, then a determination may be made as to whether there is a user session currently open or if a new session is to be initiated. If there is a user session currently open, then the session identifier associated with the open user session may be identified and assigned to each newly detected interaction. If there is no user session open, then a new session identifier may be created, and the new session identifier may be assigned to each real-time interaction detected during the user session. Furthermore, based on the device identifier, prior event data, representing prior interactions of user device 104 and server 130 during a previous user session, may be retrieved. The encoded representation (e.g., embedding) may be generated using first artificial intelligence model 114 based on the prior event data (i.e., the previous interactions detected during the previous user session) and the event data (i.e., real-time interactions 106).

In operation 604, event data detected during the user session may be extracted. The event data may represent real-time interactions 106 between user device 104 and server 130. The real-time interactions may include inputs detected by user device 104 while a corresponding user visits a webpage, mobile application, or other service, accessed via server 130. In some embodiments, each interaction detected during the user session may be logged in interaction log 110, storing a time of each event, a device identifier associated with user device 104 that participated in the event, a session identifier associated with the user session, other information, or combinations thereof. For example, a type of event (e.g., selection of a hyperlink directed to a webpage, a request submitted to a service provider associated with the webpage, a communication sent to server 130 or another device, etc.), values associated with the event (e.g., if the event is a purchase, a value of the purchase), or other data may be stored in interaction log 110.

In operation 606, event data 112, including real-time interactions 106, may be input into first artificial intelligence model 114 during the current user session. First artificial intelligence model 114 may generate encoded representation 116 of real-time interactions 106 based on event data 112. First artificial intelligence model 114, as mentioned above, may be trained by minimizing a loss between reference real-time interactions and reconstructed real-time interactions to learn how to represent real-time interactions in an embedding space.

In some embodiments, inputting event data 112 into first artificial intelligence model 114 to obtain encoded representation 116 of real-time interactions 106 includes tokenizing real-time interactions 106 to obtain a plurality of interaction tokens. Each interaction token represents one of real-time interactions 106. A plurality of token-level encoded representations may be generated for the plurality of interaction tokens. Each encoded representation of real-time interactions 106 may include the plurality of token-level encoded representations. As an example, each token-level encoded representation is an embedding representing a given real-time interaction.

In some embodiments, computing system 102 may be configured to determine a number of interactions included within real-time interactions 106. The number of interactions refers to the number of distinct interactions detected during a given user session. Each real-time interaction corresponds to a transmission of data between user device 104 and server 130.

In some embodiments, a determination may be made as to whether the number of interactions included in real-time interactions 106 is less than a threshold number of interactions. If so, computing system 102 may be configured to pad real-time interactions 106 with null values such that the number of interactions is increased to be the threshold number of interactions. In this scenario, event data 112 input to first artificial intelligence model 114 may include real-time interactions 106 with the null values serving as padding.

In operation 608, encoded representation 116 may be provided, during the user session, to second artificial intelligence model 118. Second artificial intelligence model 118 may be trained to select first data, such as data 122, to be presented within a user interface to be rendered using user device 104. Data 122 may be selected based on other data previously provided to one or more other users. The other users may be determined based on how similar they are to the user associated with user device 104. For example, a distance metric may be computed between encoded representation 116 (e.g., an embedding) and encoded representations of other users who also interact, via their respective user devices, with server 130. Users whose encoded representations are determined to be similar to encoded representation 116 may be identified, and the content previously provided to those users, or the content previously selected by those users, may be identified. Data 122 provided to user device 104 may be selected from the content previously provided and/or selected by those users.

In some embodiments, the user interface displayed on user device 104 including data 122 may be generated during the user session. The user interface may include at least some of data 122. The user interface may also be provided to user device 104 during the user session. In addition, instructions may be provided to user device 104 to cause the user interface to be rendered.

In some embodiments, during the (same) user session, the user interface may be updated. For instance, the user interface may be updated to include additional data determined based on one or more additional real-time interactions of user device 104, or another user device associated with the user, with server 130 detected during the user session subsequent to the user interface being provided to user device 104. In some cases, updated event data including an updated set of real-time interactions may be generated. The updated event data may also be generated during the user session. The updated event data may include real-time interactions 106 and the additional real-time interactions detected during the user session. In some embodiments, the additional interactions may be provided as they are detected (i.e., in real time). Upon receiving the updated event data, during the user session, an encoded representation (e.g., an embedding) representing the updated set of real-time interactions may be generated. This encoded representation, for instance, may be generated using an encoder (e.g., encoder 420, after training has completed) of first artificial intelligence model 114. This encoded representation may, subsequent to being generated, be input into second artificial intelligence model 118 to obtain the additional data to be provided to user device 104 via the updated user interface.

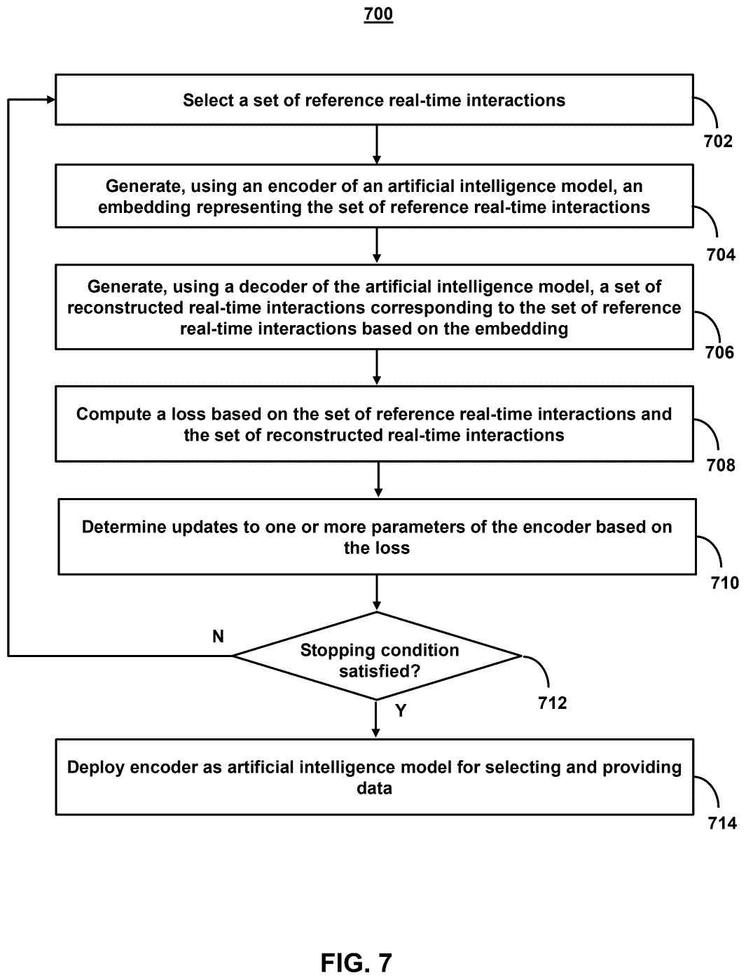

FIG. 7 illustrates a flowchart of an example process 700 for training an artificial intelligence model to generate embeddings representing real-time interactions of a user and a server, in accordance with one or more embodiments. In one or more examples, FIG. 4 is used as reference to describe various operations of process 700. In some embodiments, process 700 for training an artificial intelligence model, such as artificial intelligence model 410, may include training the model using self-supervised learning. Some examples include training artificial intelligence model 410 using reference event data representing reference real-time interactions, such as reference real-time interactions 404. The reference real-time interactions may include sets of reference real-time interactions respectively associated with a set of reference users (e.g., reference users 202 from FIG. 2). Reconstructed real-time interactions 408 may include sets of reconstructed versions of reference real-time interactions 404 respectively associated with the sets of reference real-time interactions included in training data 402.

In some embodiments, process 700 for training the artificial intelligence model may include training an encoder-decoder model, such as a transformer model. In this example, the transformer model includes an encoder (e.g., encoder 420), which generates an encoded representation (e.g., embedding 422) of the input data (i.e., reference real-time interactions 404), and a decoder (e.g., decoder 430), which generates a reconstruction of the input data (e.g., reconstructed real-time interactions 408) based on the encoded representation. After training, the encoder may be used as the first artificial intelligence model. For example, process 700 may produce a trained artificial intelligence model that can be deployed as first artificial intelligence model 114. In some embodiments, upon completion of process 700, encoder 420 may be deployed as first artificial intelligence model 114. In some embodiments, process 700 may begin at operation 702.

In operation 702, a set of reference real-time interactions may be selected. Referring to FIG. 4 for illustration, reference real-time interactions 404 may be selected from sets of reference real-time interactions, each corresponding to a different reference user, included in training data 402. In some embodiments, training the first artificial intelligence model may include retrieving training data 402 including a plurality of sets of reference real-time interactions each associated with a reference user. Each set of reference real-time interactions 404 may comprise interactions between the reference user operating user device 104 and server 130. In some embodiments, reference real-time interactions 404 may be derived from real interactions of users with server 130. In one or more examples, the selection of reference real-time interactions 404 may be random.

In operation 704, embedding 422 may be generated using encoder 420 of artificial intelligence model 410. Embedding 422 may represent reference real-time interactions in a compressed format, consumable by one or more computing devices for further analysis and processing. In one or more examples, encoder 420 may be a pre-trained encoder. Alternatively, encoder 420 may be initialized prior to training.

In operation 706, reconstructed real-time interactions 408 may be generated using decoder 430 of artificial intelligence model 410. Reconstructed real-time interactions 408 may be generated by decoder 430 based on embedding 422. Decoder 430 may be trained to map embedding 422 to a predicted reconstruction of reference real-time interactions 404.

In operation 708, loss 440 may be computed based on reference real-time interactions 404 and reconstructed real-time interactions 408. For example, a difference between reference real-time interactions 404 and reconstructed real-time interactions 408 may be computed to use as loss 440. In some embodiments, reconstructed real-time interactions 408 may include a predicted sequence of events that represents what artificial intelligence model 410 believes the input data, in this example, reference real-time interactions 404, looks like. Loss 440 may indicate how well the model performed the reconstruction. The greater the loss is, the worse a job the model did at reconstructing the set of real-time interactions. Conversely, a small loss may indicate that the model was able to accurately reconstruct the set of real-time interactions.

For example, a simple sequence of events (e.g., reference real-time interactions 404) may include three events: event E1, event E2, and event E3. In the example, each event may have a value associated with it: {event E1, value v1}, {event E2, value v2}, {event E3, value v3}. These values may represent an amount of data exchanged during a given interaction between user device 104 and server 130, a type of request submitted by user device 104, a resource identifier of a service being provided by server 130 for use by user device 104, and the like. Encoder 420 may generate an embedding representing the sequence of events E1-E3. This embedding may be input to decoder 430, which may generate a reconstructed sequence of events E1*-E3* (e.g., reconstructed real-time interactions 408). The reconstructed sequence of events may include three events: event E1*, event E2*, and event E3*. Each event may also include a reconstructed value, generated based on the mapping of the embedding to event sequences, such as, for example, {event E1*, value v1*}, {event E2*, value v2*}, {event E3*, value v3*}. In some embodiments, a loss may be computed by determining how similar the two sequences are to one another.

In operation 710, updates 450 may be determined. Updates 450 may indicate how one or more parameters of encoder 420 and/or artificial intelligence model 410 are to be adjusted based on loss 440. For example, updates 450 may be determined so as to minimize loss 440. In some embodiments, one or more optimization algorithms may be used to determine updates 450.

In operation 712, a determination may be made as to whether one or more stopping conditions have been satisfied. As an example, the stopping conditions may be satisfied based on a determination that each of the sets of reference real-time interactions included in training data 402 has been analyzed. As another example, the stopping conditions may be satisfied based on a determination that loss 440 computed from a given set of real-time interactions and a corresponding set of reconstructed real-time interactions is less than a threshold loss. As yet another example, the stopping condition may be satisfied based on a determination that a predefined number of training epochs have been performed and/or a threshold amount of time for training has elapsed.

If, in operation 712, it is determined that the stopping conditions have not been satisfied, process 700 may return to operation 702. At operation 702, another set of reference real-time interactions may be selected from training data 402, and operations 704-712 may repeat. The other set of reference real-time interactions that are selected may correspond to another reference user. In one or more examples, the other set of reference real-time interactions may be selected randomly.

However, if at operation 712 it is determined that one or more of the stopping conditions have been satisfied, process 700 may proceed to operation 714. In operation 714, encoder 420 may be deployed as first artificial intelligence model 114. In some embodiments, deploying first artificial intelligence model 114 may include providing real-time production data to first artificial intelligence model 114 to generate embeddings and provide those embeddings to second artificial intelligence model 118 to select and provide data 122 to user device 104.

It is contemplated that the steps or descriptions of FIGS. 6 and 7 may be used with any other embodiment of this disclosure. In addition, the steps and descriptions described in relation to FIGS. 6 and 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIGS. 6 and 7.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for generating an embedding representing real-time interactions of a user device and a server.

2. The method of embodiment 1, wherein the embedding is used for selecting and providing data.

3. The method of any one of embodiments 1-2, comprising: determining that a user session between a user device of a user and a server has been initiated; extracting event data detected during the user session, the event data representing real-time interactions of the user device with the server; inputting, during the user session, the event data into a first artificial intelligence model to obtain an encoded representation of the real-time interactions, wherein the first artificial intelligence model is trained by minimizing a loss between reference real-time interactions and reconstructed real-time interactions; providing, during the user session, the encoded representation to a second artificial intelligence model, wherein the second artificial intelligence model is trained to select first data to be presented within a user interface to be rendered using the user device, wherein the first data is selected based on second data provided to one or more other users determined to be similar to the user.

4. The method of embodiment 3, further comprising: training, using self-supervised learning, the first artificial intelligence model using reference event data representing the reference real-time interactions.

5. The method of embodiment 4, wherein the reference real-time interactions comprise sets of reference real-time interactions respectively associated with a set of training users.

6. The method of embodiment 4 or 5, wherein the reconstructed real-time interactions comprise sets of reconstructed real-time interactions respectively associated with the sets of reference real-time interactions.

7. The method of any one of embodiments 3-6, wherein the first artificial intelligence model comprises an encoder from a trained transformer model comprising the encoder and a decoder.

8. The method of embodiment 7, wherein training the first artificial intelligence model comprises: for each of the sets of reference real-time interactions: generating, using the encoder, an embedding representing the set of reference real-time interactions; generating, using the decoder, a set of reconstructed real-time interactions corresponding to the set of reference real-time interactions based on the embedding; and updating the encoder based on a loss computed from the set of reference real-time interactions and the set of reconstructed real-time interactions.

9. The method of embodiment 8, wherein the encoder is deployed as the first artificial intelligence model subsequent to one or more stopping conditions associated with the training being satisfied.

10. The method of embodiment 8 or 9, further comprising: selecting the set of reference real-time interactions from the sets of reference real-time interactions.

11. The method of embodiment 10, wherein the set of reference real-time interactions is selected randomly from the sets of reference real-time interactions.

12. The method of any one of embodiments 9-11, wherein the one or more stopping conditions being satisfied comprises: determining that each of the sets of reference real-time interactions has been analyzed.

13. The method of any one of embodiments 9-11, wherein the one or more stopping conditions being satisfied comprises: determining that the loss is less than a threshold loss.

14. The method of any one of embodiments 9-11, wherein the one or more stopping conditions being satisfied comprises: determining that a predefined number of training epochs have elapsed.

15. The method of any one of embodiments 3-14, wherein determining that the user session has been initiated comprises: receiving a notification that the user device has accessed a webpage associated with the server; and generating a session identifier for the user session based on the notification, wherein the real-time interactions are stored in association with the session identifier.

16. The method of any one of embodiments 3-15, wherein the real-time interactions comprise inputs detected by the user device while the user visits a webpage hosted by the server.

17. The method of any one of embodiments 3-16, further comprising: generating, during the user session, the user interface to comprising the at least some of the first data; and providing, during the user session, the user interface to the user device including instructions to cause the user interface to be rendered.

18. The method of embodiment 17, further comprising: updating, during the user session, the user interface provided to the user interface to include additional data determined based on one or more additional real-time interactions of the user with a server detected during the user session subsequent to the user interface being provided to the user device.

19. The method of embodiment 18, wherein the encoded representation comprises a first encoded representation, the method further comprises: generating, during the user session, updated event data comprising an updated set of real-time interactions including the real-time interactions and one or more additional real-time interactions; generating, using the updated event data, during the user session, a second encoded representation representing the updated set of real-time interactions; and inputting, during the user session, the second encoded representation into the second artificial intelligence model to obtain the additional data to be provided to the user device via the updated user interface.

20. The method of any one of embodiments 3-19, wherein determining that the user session has been initiated comprises: accessing a device identifier of the user device; and determining, based on the device identifier, that the user session is a first user session between the user device and the server.

21. The method of any one of embodiments 3-20, wherein inputting the event data into the first artificial intelligence model to obtain the encoded representation of the real-time interactions comprises: tokenizing the real-time interactions to obtain a plurality of interaction tokens, wherein each interaction token represents one of the real-time interactions; and generating a plurality of token-level encoded representations for the plurality of interaction tokens, wherein the encoded representation of the real-time interactions comprises the plurality of token-level encoded representations.

22. The method of any one of embodiments 3-21, further comprising: determining a number of interactions included within the real-time interactions; determining that the number of interactions is less than a threshold number of interactions; and padding the real-time interactions based on the number of interactions being less than the threshold number of interactions.

23. The method of embodiment 22, wherein the real-time interactions are padded with null values such that the number of interactions is increased to be the threshold number of interactions.

24. The method of embodiment 23, wherein the event data input to the first artificial intelligence model comprises the real-time interactions including the null values.

25. The method of any one of embodiments 3-24, further comprising: steps for training the second artificial intelligence model to identify data to be included within user interfaces based on encoded representations.

26. The method of any one of embodiments 3-25, wherein determining that the user session has been initiated comprises: accessing a device identifier of the user device; and obtaining, based on the device identifier, prior event data representing prior interactions of the user device and the server during a previous user session.

27. The method of embodiment 26, wherein: the encoded representation is generated by the first artificial intelligence model based on the prior event data and the event data.

28. The method of any one of embodiments 3-27, further comprising: determining a session stopping condition has been satisfied; and ending the user session based on the session stopping condition being satisfied.

29. The method of embodiment 28, wherein ending the user session comprises: preventing the first data from being accessed via the user interface.

30. The method of embodiment 28, wherein determining the session stopping condition has been satisfied comprises: determining that a threshold amount of time has elapsed since a most recent interaction was detected.

31. The method of embodiment 28, wherein determining the session stopping condition has been satisfied comprises: determining that a graphical user interface rendered on the user interface has been selected.

32. The method of embodiment 28, wherein determining the session stopping condition has been satisfied comprises: determining that a request to stop rendering of the user interface has been received from the user device.

33. One or more non-transitory, machine-readable media storing instructions that, when executed by one or more data processing apparatuses, cause operations comprising those of any of embodiments 1-32.

34. A system comprising one or more processors and memory storing instructions that, when executed by the processors, cause the processors to effectuate operations comprising those of any of embodiments 1-32.

35. A system comprising means for performing any of embodiments 1-32.

36. A system comprising cloud-based circuitry for performing any of embodiments 1-32.

37. A service provider comprising one or more processors programmed to perform any of embodiments 1-32.

What is claimed is:

1. A system for selecting and providing data to a user based on a real-time analysis of interactions of the user and a server, the system comprising:
one or more processors programmed to:
initiate a user session between a user device associated with a user and a server based on a determination that the user has accessed a webpage hosted by the server;
responsive to the user session being initiated, extract real-time event data detected during the user session, the real-time event data representing real-time interactions of the user device with the server;
input, during the user session, the real-time event data into a transformer model to obtain an embedding representing the real-time interactions, the transformer model comprising an encoder and a decoder, and wherein:
reference real-time event data representing sets of reference real-time interactions of training users with the server is input to the encoder to obtain training embeddings respectively representing the sets of reference real-time interactions,
the training embeddings are each input to the decoder to obtain reconstructed real-time event data representing sets of reconstructed real-time interactions, and
one or more parameters of the transformer model are updated based on a loss computed using the reference real-time event data and the reconstructed real-time event data;
input, during the user session, the embedding into a trained artificial intelligence model to obtain first data to be provided to the user, wherein the first data is selected based on second data provided to one or more other users, wherein the one or more other users are identified to be similar to the user based on the embedding and embeddings generated for the one or more other users; and
responsive to the first data being selected, generate and provide, during the user session, a user interface to the user device, wherein the user interface is configured to present the first data.

2. A method for selecting and providing data based on a real-time analysis of interactions with a server, the method being implemented using one or more processors of a computing system, the method comprising:
determining that a user session between a user device of a user and a server has been initiated;
extracting event data detected during the user session, the event data representing real-time interactions of the user device with the server;
inputting, during the user session, the event data into a first artificial intelligence model to obtain an encoded representation of the real-time interactions, wherein the first artificial intelligence model is trained by minimizing a loss between reference real-time interactions and reconstructed real-time interactions; and
providing, during the user session, the encoded representation to a second artificial intelligence model, wherein the second artificial intelligence model is trained to select first data to be presented within a user interface to be rendered using the user device, wherein the first data is selected based on second data provided to one or more other users determined to be similar to the user.

3. The method of claim 2, further comprising:
training, using self-supervised learning, the first artificial intelligence model using reference event data representing the reference real-time interactions, wherein the reference real-time interactions comprise sets of reference real-time interactions respectively associated with a set of training users and the reconstructed real-time interactions comprise sets of reconstructed real-time interactions respectively associated with the sets of reference real-time interactions.

4. The method of claim 3, wherein the first artificial intelligence model comprises an encoder from a trained transformer model comprising the encoder and a decoder.

5. The method of claim 4, wherein training the first artificial intelligence model comprises:
for each of the sets of reference real-time interactions:
generating, using the encoder, an embedding representing the set of reference real-time interactions;
generating, using the decoder, a set of reconstructed real-time interactions corresponding to the set of reference real-time interactions based on the embedding; and
updating the encoder based on a loss computed from the set of reference real-time interactions and the set of reconstructed real-time interactions, wherein:
the encoder is deployed as the first artificial intelligence model subsequent to one or more stopping conditions associated with the training being satisfied.

6. The method of claim 5, wherein the one or more stopping conditions being satisfied comprises:
determining that each of the sets of reference real-time interactions has been analyzed;
determining that the loss is less than a threshold loss; or
determining that a predefined number of training epochs have elapsed.

7. The method of claim 2, wherein determining that the user session has been initiated comprises:
receiving a notification that the user device has accessed a webpage associated with the server; and
generating a session identifier for the user session based on the notification, wherein the real-time interactions are stored in association with the session identifier.

8. The method of claim 2, wherein the real-time interactions comprise inputs detected by the user device while the user visits a webpage hosted by the server.

9. The method of claim 2, further comprising:
generating, during the user session, the user interface to comprising the at least some of the first data; and
providing, during the user session, the user interface to the user device including instructions to cause the user interface to be rendered.

10. The method of claim 9, further comprising:
updating, during the user session, the user interface provided to the user interface to include additional data determined based on one or more additional real-time interactions of the user with a server detected during the user session subsequent to the user interface being provided to the user device.

11. The method of claim 10, wherein the encoded representation comprises a first encoded representation, the method further comprises:
generating, during the user session, updated event data comprising an updated set of real-time interactions including the real-time interactions and one or more additional real-time interactions;
generating, using the updated event data, during the user session, a second encoded representation representing the updated set of real-time interactions; and
inputting, during the user session, the second encoded representation into the second artificial intelligence model to obtain the additional data to be provided to the user device via the updated user interface.

12. The method of claim 2, wherein determining that the user session has been initiated comprises:
accessing a device identifier of the user device; and
determining, based on the device identifier, that the user session is a first user session between the user device and the server.

13. The method of claim 2, wherein inputting the event data into the first artificial intelligence model to obtain the encoded representation of the real-time interactions comprises:
tokenizing the real-time interactions to obtain a plurality of interaction tokens, wherein each interaction token represents one of the real-time interactions; and
generating a plurality of token-level encoded representations for the plurality of interaction tokens, wherein the encoded representation of the real-time interactions comprises the plurality of token-level encoded representations.

14. The method of claim 2, further comprising:
determining a number of interactions included within the real-time interactions;
determining that the number of interactions is less than a threshold number of interactions; and
padding the real-time interactions with null values such that the number of interactions is increased to be the threshold number of interactions, wherein the event data input to the first artificial intelligence model comprises the real-time interactions including the null values.

15. The method of claim 2, further comprising:
steps for training the second artificial intelligence model to identify data to be included within user interfaces based on encoded representations.

16. The method of claim 2, wherein determining that the user session has been initiated comprises:
accessing a device identifier of the user device; and
obtaining, based on the device identifier, prior event data representing prior interactions of the user device and the server during a previous user session, wherein:
the encoded representation is generated by the first artificial intelligence model based on the prior event data and the event data.

17. The method of claim 2, further comprising:
determining a session stopping condition has been satisfied; and
ending the user session based on the session stopping condition being satisfied.

18. The method of claim 17, wherein ending the user session comprises:
preventing the first data from being accessed via the user interface.

19. The method of claim 17, wherein determining the session stopping condition has been satisfied comprises:
determining that a threshold amount of time has elapsed since a most recent interaction was detected;
determining that a graphical user interface rendered on the user interface has been selected; or
determining that a request to stop rendering of the user interface has been received from the user device.

20. One or more non-transitory, computer-readable media storing computer program instructions that, when executed by one or more processors, effectuate operations comprising:
determining that a user session between a user device of a user and a server has been initiated;
extracting event data detected during the user session, the event data representing real-time interactions of the user device with the server;
inputting, during the user session, the event data into a first artificial intelligence model to obtain an encoded representation of the real-time interactions, wherein the first artificial intelligence model is trained by minimizing a loss between reference real-time interactions and reconstructed real-time interactions; and
providing, during the user session, the encoded representation to a second artificial intelligence model, wherein the second artificial intelligence model is trained to select first data to be presented within a user interface to be rendered using the user device, wherein the first data is selected based on second data provided to one or more other users determined to be similar to the user.
